(19) United States
(12) Patent Application Publication
(10) Pub. No.: US 2025/0236779 A1
(43) Pub. Date: Jul. 24, 2025

(54) OIL-BASED DRILLING FLUIDS AND METHODS THEREOF

(71) Applicant: SAUDI ARABIAN OIL COMPANY, Dhahran (SA)

(72) Inventors: Subhash AYIRALA, Dhahran (SA); Salah SALEH, Dhahran (SA); Jothibasu RAMASAMY, Dhahran (SA); Mohammed K. ARFAJ, Dhahran (SA)

(73) Assignee: SAUDI ARABIAN OIL COMPANY, Dhahran (SA)

(21) Appl. No.: 18/418,598

(22) Filed: Jan. 22, 2024

(51) Int. Cl. C09K 8/26

(52) U.S. Cl. CPC C09K 8/26

(57) ABSTRACT

Oil-based drilling fluids of the present application may comprise a base fluid, wherein the base fluid is an emulsion comprising an oil and an aqueous fluid; wherein the aqueous fluid comprises a concentrated brine obtained from desalinating a produced water; and one or more additives. Methods for using oil-based drilling fluids may comprise performing desalination on a produced water to obtain a concentrated brine; and operating a drill in a wellbore in the presence of a drilling fluid comprising a base fluid, wherein the base fluid is an emulsion comprising an oil and an aqueous fluid; wherein the aqueous fluid comprises the concentrated brine; and one or more additives.

### FIELD OF THE DISCLOSURE

The present disclosure relates generally to drilling fluids and, more particularly, to oil-based drilling fluids.

### BACKGROUND OF THE DISCLOSURE

During drilling operations, a drilling fluid, which may also be referred to as drilling mud, is circulated through the wellbore to cool the drill bit, to convey rock cuttings to the surface, or to support the wellbore against the collapse of the wellbore and intrusion of fluids from the formation, among other purposes. Drilling fluids commonly comprise at least some amount of water, which may be obtained from a variety of sources.

Substantial amounts of produced water are generated from oil and gas fields globally. There is an increasing inclination toward treating this hypersaline byproduct to yield low-salinity water, thereby fostering the objectives of a circular water economy and advancing environmental sustainability. Notable desalination technologies that are garnering attention at present include dynamic vapor compression (DyVaR) and carrier gas extraction (CGE). While these highly proficient evaporation and humidification/dehumidification methodologies achieve commendable water recoveries ranging from 70% to 90%, they concurrently result in the discharge of approximately 10% to 30% of concentrated brines as waste. This release of concentrated waste from desalination processes poses significant environmental challenges, especially if deposited on terrestrial regions or aquatic bodies.

The purified water derived from both DyVaR and CGE has a range of upstream applications, encompassing reservoir re-injection, makeup water for various improved/enhanced oil recovery (IOR/EOR) processes, specific low salinity water for unconventional fracking and tight gas wells, and water for crude oil desalting. This purified water may also serve as a potential resource for irrigation. However, reintroducing 10% to 30% of concentrated waste brines into marine environments may detrimentally impact marine life in the vicinity. Terrestrial discharges result in salt residue accumulations post-evaporation. Given the elevated salinity levels of the discharged water, opportunities for its recycling are notably restricted. The identification of viable applications for recycling this wastewater is imperative to achieve a holistic circular economy and further the cause of environmental sustainability.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, oil-based drilling fluids may comprise a base fluid, wherein the base fluid is an emulsion comprising an oil and an aqueous fluid; wherein the aqueous fluid comprises a concentrated brine obtained from desalinating a produced water; and one or more additives.

In another embodiment, methods for using oil-based drilling fluids may comprise performing desalination on a produced water to obtain a concentrated brine; and operating a drill in a wellbore in the presence of a drilling fluid comprising a base fluid, wherein the base fluid is an emulsion comprising an oil and an aqueous fluid; wherein the aqueous fluid comprises the concentrated brine; and one or more additives.

In a further embodiment, oil-based drilling fluids may comprise a base fluid, wherein the base fluid is an emulsion comprising an oil and an aqueous fluid; wherein the oil comprises diesel, Safra oil, or a combination thereof; wherein the aqueous fluid comprises about 25 vol % to about 75 vol % of a concentrated brine obtained from desalinating a produced water; a viscosifier; an emulsifier; a weighting material; a fluid-loss additive; and an alkaline compound.

Any combination of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

Not applicable.

### DETAILED DESCRIPTION

Embodiments in accordance with the present disclosure generally relate to drilling fluids and, more particularly, to oil-based drilling fluids. As mentioned previously, the identification of viable applications for recycling the concentrated brine byproduct of produced water desalination is imperative to achieve a holistic circular water economy and further the cause of environmental sustainability. The present disclosure delineates the utilization of the concentrated brine to formulate oil-based drilling fluids, thereby advancing the objectives of a complete circular water economy and precluding waste emissions into the environment. This advancement furnishes a dual-faceted technological solution. Primarily, it facilitates the recycling of wastewater, mitigating the environmental disposal challenges. Furthermore, the compositions and methods of the present disclosure have the potential to conserve considerable quantities of freshwater from terrestrial sources.

In an embodiment, a non-limiting example drilling fluid may comprise a base fluid, wherein the base fluid is an emulsion comprising an oil and an aqueous fluid; wherein the aqueous fluid comprises a concentrated brine obtained from desalinating a produced water; and one or more additives.

In another embodiment, a drilling fluid may comprise a base fluid, wherein the base fluid is an emulsion comprising an oil and an aqueous fluid; wherein the oil comprises diesel, Safra oil, or a combination thereof; wherein the aqueous fluid comprises about 25 vol % to about 75 vol % of a concentrated brine obtained from desalinating a produced water; a viscosifier; an emulsifier; a weighting material; a fluid-loss additive; and an alkaline compound.

The drilling fluids of the present disclosure may be used in various drilling operations. Such methods may comprise operating a drill in a wellbore in the presence of a drilling fluid comprising: a base fluid, wherein the base fluid is an emulsion comprising an oil and an aqueous fluid; wherein the aqueous fluid comprises a concentrated brine obtained from desalinating a produced water; and one or more additives.

To drill a subterranean well, a drill string, including a drill bit and drill collars to weight the drill bit, may be inserted into a predrilled hole and rotated to cause the drill bit to cut into the rock at the bottom of the hole. The drilling operation produces rock fragments. To remove the rock fragments from the bottom of the wellbore, a drilling fluid, such as a drilling fluid of the present disclosure, may be pumped down through the drill string to the drill bit. The drilling fluid cools the drill bit and lifts the rock fragments known as cuttings away from the drill bit. The drilling fluid carries the cuttings upwards as the drilling fluid is recirculated back to the surface. At the surface, the cuttings may be removed from the drilling fluid through a secondary operation, and the drilling fluid may be recirculated back down the drill string to the bottom of the wellbore for collection of further cuttings. It will be appreciated by one skilled in the art that multiple terms familiar to those skilled in the art may be used to describe the same thing. For example, a subterranean well may alternatively be called a borehole or wellbore and usage of a single term is meant to encompass each of the related terms as well.

Drilling fluids include drilling muds, packer fluids, and completion fluids. As used herein, “drilling fluid” means any fluid used to aid the drilling of boreholes into subterranean formations. As used herein, “completion fluids” are solids-free liquid used to “complete” an oil or gas well. Specifically, this fluid is placed in the well to facilitate final operations prior to initiation of production, such as setting screen production liners, downhole valves, or shooting perforations into the producing zone. The fluid is meant to control a well should downhole hardware fail, without damaging the producing formation or completion components. As used here, a “packer fluid” is a fluid that is left in the annular region of a well between tubing and outer casing above a packer. The main functions of a packer fluid are: (1) to provide hydrostatic pressure in order to lower differential pressure across the sealing element, (2) to lower differential pressure on the wellbore and casing to prevent collapse, and (3) to protect metals and elastomers from corrosion. Generically, drilling fluids serve a number of functions with different types specializing in a particular function or functions. In one or more embodiments, a drilling fluid of the present disclosure assists in the removal of cuttings from the bottom of a borehole during drilling operations. The drilling fluid suspends the cuttings and weighted material may transport the cuttings to the borehole surface with the drilling fluid. Additionally, the drilling fluid may absorb gases in the borehole, such as carbon dioxide, hydrogen sulfide, and methane, and transport the gases to the borehole surface for release, sequestration, or burn-off. In further embodiments, the drilling fluid also provides a cooling and lubrication functionality for cooling and lubrication of the bit and drill string utilized in boring operations. The drilling fluid additionally provides buoyancy to the drill string, relieving the tension on the drill string as the length of the borehole increases. Furthermore, the drilling fluid may also control subsurface pressures. Specifically, the drilling fluid may provide hydrostatic pressure in the borehole to provide support to the sidewalls of the borehole and prevent the sidewalls from collapsing and caving in on the drill string. Additionally, the drilling fluid may provide hydrostatic pressure in the bore to prevent fluids in the downhole formations from flowing into the borehole during drilling operations.

In one or more embodiments, the base fluid of the drilling fluid may be an emulsion, such as a water-in-oil emulsion also referred to as an invert emulsion. In water-in-oil emulsions or invert emulsions, oil is a continuous phase and an aqueous fluid is dispersed in the continuous oil phase by emulsification so that the drilling fluid does not have a distinct water layer. The oil may be a natural or synthetic oil. For example, the oil may comprise diesel, Safra oil, kerosene, fuel oil, crude oil, mineral oil, or any combination thereof.

The aqueous fluid may comprise a concentrated brine obtained from a produced water that has been desalinated to obtain a treated water and a concentrated brine. As used herein, the term “produced water” refers to water that is produced as a byproduct during the extraction of hydrocarbons. The produced water may contain a high concentration of dissolved solids (e.g., salts).

The produced water may be desalinated as a method to produce a treated water having a lower concentration of the dissolved solids than the produced water. Techniques including, but not limited to, evaporation, humidification/dehumidification, distillation, osmosis (e.g., reverse osmosis), freeze-thaw, electrodialysis, microbial desalination, the like, and any combination thereof may be used to desalinate the produced water.

In addition to the treated water, the process of desalination also produces a concentrated brine having a higher concentration of dissolved solids than the produced water as a byproduct. For example, the concentrated brine may have a total dissolved solids concentration of about 50,000 mg/mL to about 1,000,000 mg/L, or about 50,000 mg/L to about 500,000 mg/L, or about 50,000 mg/L to about 250,000 mg/L, or about 50,000 mg/L to about 100,000 mg/L, or about 100,000 mg/L to about 1,000,000 mg/L, or about 100,000 mg/L to about 500,000 mg/L, or about 100,000 mg/L to about 250,000 mg/L, or about 250,000 mg/L to about 1,000,000 mg/L, or about 250,000 mg/L to about 500,000 mg/L, or about 500,000 mg/L to about 1,000,000 mg/L.

The dissolved solids may be in the form of dissolved cations and/or anions of various minerals. The metal ions in the concentrated brine may, for example, comprise a sodium ion, a calcium ion, a magnesium ion, a potassium ion, or any combination thereof. Sodium ions may account for a majority of the total dissolved solids in the concentrated brine. For example, a concentration of sodium ions in the concentrated brine may be about 10,000 mg/mL to about 500,000 mg/mL, or about 10,000 mg/mL to about 400,000 mg/mL, or about 10,000 mg/mL to about 300,000 mg/mL, or about 10,000 mg/mL to about 200,000 mg/mL, or about 10,000 mg/mL to about 100,000 mg/mL, or about 100,000 mg/mL to about 500,000 mg/mL, or about 100,000 mg/mL to about 400,000 mg/mL, or about 100,000 mg/mL to about 300,000 mg/mL, or about 100,000 mg/mL to about 200,000 mg/mL, or about 200,000 mg/mL to about 500,000 mg/mL, or about 200,000 mg/mL to about 400,000 mg/mL, or about 200,000 mg/mL to about 300,000 mg/mL, or about 300,000 mg/mL to about 500,000 mg/mL, or about 300,000 mg/mL to about 400,000 mg/mL, or about 400,000 mg/mL to about 500,000 mg/mL.

Furthermore, the metal ions in the concentrated brine may comprise at least one or more divalent metal ions, such as calcium ions, magnesium ions, or a combination thereof. A concentration of calcium ions in the concentrated brine may, for example, be about 1,000 mg/mL to about 50,000 mg/mL, or about 1,000 mg/mL to about 40,000 mg/mL, or about 1,000 mg/mL to about 30,000 mg/mL, or about 1,000 mg/mL to about 20,000 mg/mL, or about 1,000 mg/mL to about 10,000 mg/mL, or about 10,000 mg/mL to about 50,000 mg/mL, or about 10,000 mg/mL to about 40,000 mg/mL, or about 10,000 mg/mL to about 30,000 mg/mL, or about 10,000 mg/mL to about 20,000 mg/mL, or about 20,000 mg/mL to about 50,000 mg/mL, or about 20,000 mg/mL to about 40,000 mg/mL, or about 20,000 mg/mL to about 30,000 mg/mL, or about 30,000 mg/mL to about 50,000 mg/mL, or about 30,000 mg/mL to about 40,000 mg/mL, or about 40,000 mg/mL to about 50,000 mg/mL.

A concentration of magnesium ions in the concentrated brine may, for example, be about 100 mg/L to about 5,000 mg/L, or about 100 mg/L to about 1,000 mg/L, or about 100 mg/L to about 800 mg/L, or about 100 mg/L to about 600 mg/L, or about 100 mg/L to about 400 mg/L, or about 100 mg/L to about 200 mg/L, or about 200 mg/L to about 5,000 mg/L, or about 200 mg/L to about 1,000 mg/L, or about 200 mg/L to about 800 mg/L, or about 200 mg/L to about 600 mg/L, or about 200 mg/L to about 400 mg/L, or about 400 mg/L to about 5,000 mg/L, or about 400 mg/L to about 1,000 mg/L, or about 400 mg/L to about 800 mg/L, or about 400 mg/L to about 600 mg/L, or about 600 mg/L to about 5,000 mg/L, or about 600 mg/L to about 1,000 mg/L, or about 600 mg/L to about 800 mg/L, or about 800 mg/L to about 5,000 mg/L, or about 800 mg/L to about 1,000 mg/L, or about 1,000 mg/L to about 5,000 mg/L.

A concentration of potassium ions in the concentrated brine may, for example, be about 100 mg/L to about 5,000 mg/L, or about 100 mg/L to about 1,000 mg/L, or about 100 mg/L to about 800 mg/L, or about 100 mg/L to about 600 mg/L, or about 100 mg/L to about 400 mg/L, or about 100 mg/L to about 200 mg/L, or about 200 mg/L to about 5,000 mg/L, or about 200 mg/L to about 1,000 mg/L, or about 200 mg/L to about 800 mg/L, or about 200 mg/L to about 600 mg/L, or about 200 mg/L to about 400 mg/L, or about 400 mg/L to about 5,000 mg/L, or about 400 mg/L to about 1,000 mg/L, or about 400 mg/L to about 800 mg/L, or about 400 mg/L to about 600 mg/L, or about 600 mg/L to about 5,000 mg/L, or about 600 mg/L to about 1,000 mg/L, or about 600 mg/L to about 800 mg/L, or about 800 mg/L to about 5,000 mg/L, or about 800 mg/L to about 1,000 mg/L, or about 1,000 mg/L to about 5,000 mg/L.

In addition to these cations, the concentrated brine may further comprise anions such as a chloride anion, a bicarbonate anion, a sulfate anion, or any combination thereof. For example, the concentrated brine may have a concentration of chloride anions of about 10,000 mg/L to about 500,000 mg/mL, or about 10,000 mg/mL to about 400,000 mg/mL, or about 10,000 mg/mL to about 300,000 mg/mL, or about 10,000 mg/mL to about 200,000 mg/mL, or about 10,000 mg/mL to about 100,000 mg/mL, or about 100,000 mg/mL to about 500,000 mg/mL, or about 100,000 mg/mL to about 400,000 mg/mL, or about 100,000 mg/mL to about 300,000 mg/mL, or about 100,000 mg/mL to about 200,000 mg/mL, or about 200,000 mg/mL to about 500,000 mg/mL, or about 200,000 mg/mL to about 400,000 mg/mL, or about 200,000 mg/mL to about 300,000 mg/mL, or about 300,000 mg/mL to about 500,000 mg/mL, or about 300,000 mg/mL to about 400,000 mg/mL, or about 400,000 mg/mL to about 500,000 mg/mL.

A concentration of bicarbonate anions in the concentrated brine may, for example, be about 10 mg/L to about 1,000 mg/L, or about 10 mg/L to about 800 mg/L, or about 10 mg/L to about 600 mg/L, or about 10 mg/L to about 400 mg/L, or about 10 mg/L to about 200 mg/L, or about 10 mg/L to about 100 mg/L, or about 100 mg/L to about 1,000 mg/L, or about 100 mg/L to about 800 mg/L, or about 100 mg/L to about 600 mg/L, or about 100 mg/L to about 400 mg/L, or about 100 mg/L to about 200 mg/L, or about 200 mg/L to about 1,000 mg/L, or about 200 mg/L to about 800 mg/L, or about 200 mg/L to about 600 mg/L, or about 200 mg/L to about 400 mg/L, or about 400 mg/L to about 1,000 mg/L, or about 400 mg/L to about 800 mg/L, or about 400 mg/L, to about 600 mg/L, or about 600 mg/L to about 1,000 mg/L, or about 600 mg/L to about 800 mg/L, or about 800 mg/L to about 1,000 mg/L.

A concentration of sulfate anions in the concentrated brine may, for example, be about 100 mg/L to about 10,000 mg/L, or about 100 mg/L to about 8,000 mg/L, or about 100 mg/L to about 6,000 mg/L, or about 100 mg/L to about 4,000 mg/L, or about 100 mg/L to about 2,000 mg/L, or about 100 mg/L to about 1,000 mg/L, or about 1,000 mg/L to about 10,000 mg/L, or about 1,000 mg/L to about 8,000 mg/L, or about 1,000 mg/L to about 6,000 mg/L, or about 1,000 mg/L to about 4,000 mg/L, or about 1,000 mg/L to about 2,000 mg/L, or about 2,000 mg/L to about 10,000 mg/L, or about 2,000 mg/L to about 8,000 mg/L, or about 2,000 mg/L to about 6,000 mg/L, or about 2,000 mg/L to about 4,000 mg/L, or about 4,000 mg/L to about 10,000 mg/L, or about 4,000 mg/L to about 8,000 mg/L, or about 4,000 mg/L to about 6,000 mg/L, or about 6,000 mg/L to about 10,000 mg/L, or about 6,000 mg/L to about 8,000 mg/L, or about 8,000 mg/L to about 10,000 mg/L.

In an embodiment, the concentrated brine may be used as a component of the aqueous fluid. For example, the aqueous fluid may comprise the concentrated brine at a concentration of about 25 vol % to about 75 vol %, or about 25 vol % to about 60 vol %, or about 25 vol % to about 50 vol %, or about 25 vol % to about 40 vol %, or about 40 vol % to about 75 vol %, or about 40 vol % to about 60 vol %, or about 40 vol % to about 50 vol %, or about 50 vol % to about 75 vol %, or about 50 vol % to about 60 vol %, or about 60 vol % to about 75 vol %. Preferably, the aqueous fluid may comprise about 50 vol % of the concentrated brine.

In one or more embodiments, the base fluid may comprise an oil-to-aqueous fluid ratio by volume of 50:50 to about 95:05. For example, the oil-to-water ratio by volume of the base fluid may be about 50:50 to about 80:20, or about 50:50 to about 75:25, or about 55:45 to about 85:15, or about 60:40 to about 85:15, or about 70:30 to about 85:15, or about 60:40 to about 80:20, or about 65:35 to about 75:25.

The drilling fluid may, for example, have a weight percent of base fluid of from about 1 wt % to about 99 wt %, or about 20 wt % to about 80 wt %, or about 30 wt % to about 70 wt %, or about 40 wt % to about 60 wt %, or about 45 wt % to about 55 wt % based on the total weight of the drilling fluid. In one or more embodiments, the drilling fluid comprises an amount of base fluid which is dependent upon application. For example, the amount of oil or the oil-to-aqueous fluid ratio depends on the mud weight.

The drilling fluid may comprise one or more additives to enhance at least one characteristic of the drilling fluid. Examples of suitable additives include, but are not limited to, a viscosifier, a weighting material, an emulsifier, a fluid-loss control additive, an alkaline compound, the like, and any combination thereof.

Additives such as a viscosifier may be present in the drilling fluid in sufficient quantity to gel the drilling fluid, but not at an excessive quantity to impede other properties of the drilling fluid. Specifically, the amount of viscosifier must be controlled, as too little viscosifier will not result in gelling while too much will result in excessive gelling. In one or more embodiments, the drilling fluid may comprise about 0.01 wt % to about 1 wt % of the viscosifier, based on the total weight of the drilling fluid. For example, the drilling fluid may have a concentration of the viscosifier of about 0.01 wt % to about 0.5 wt %, or about 0.75 wt %, or about 0.01 wt % to about 0.5 wt %, or about 0.01 wt % to about 0.1 wt %, or about 0.1 wt % to about 1 wt %, or about 0.1 wt % to about 0.75 wt %, or about 0.1 wt % to about 0.5 wt %.

The viscosifier may comprise conventional organophilic clay or chemical viscosifiers including, but not limited to, xanthan gum, polyacrylamide, the like, and any combination thereof. One or more of these viscosifiers may be used to impart non-Newtonian fluid rheology to the drilling fluid and facilitate lifting and conveying rock cuttings to the surface of the wellbore.

In further embodiments, additives in the drilling fluid may include a weighting material. The weighting material may have a specific gravity suited for raising the drilling fluid composition density. In one or more embodiments, the weighting material may be a particulate solid having a specific gravity sufficient to increase the density of the drilling fluid by a certain amount without adding excessive weighting material such that the drilling fluid cannot be circulated through the wellbore. The weighting material may, for example, have a specific gravity of about 2 g/cm³ to about 6 g/cm³, or about 2 g/cm³ to about 4 g/cm³, or about 4 g/cm³ to about 6 g/cm³. Examples of weighting materials include, but are not limited to, barite, calcium carbonate, siderite, ilmenite, the like, and any combination thereof. Some example drilling fluids may include barite as the solid.

In one or more embodiments, additives in the drilling fluid may include an emulsifier. For example, the drilling fluid may comprise about 7 lbₘ/bbl to about 25 lbₘ/bbl of emulsifier, or about 8 lbₘ/bbl to about 20 lbₘ/bbl of emulsifier, or about 9 lbₘ/bbl to about 15 lbₘ/bbl of emulsifier. In one or more embodiments, the emulsifier may be an invert emulsifier and oil-wetting agent for synthetic-based drilling fluid systems such as carboxylic acid-terminated polyamide. Commercially available emulsifiers include VERSAMUL™ from MI SWACO and LE SUPERMUL™ from Halliburton Energy Services, Inc.

In one or more embodiments, additives in the drilling fluid may include a fluid-loss control additive. The fluid-loss control additive may be added to the drilling fluid to reduce the amount of filtrate lost from the oil-based drilling fluid into a subterranean formation. Examples of fluid-loss control additives include lignite, bentonite, manufactured polymers, thinners, deflocculants, or any combination thereof. The drilling fluid may, for example, comprise about 1 lbₘ/bbl to about 10 lbₘ/bbl of fluid-loss control additive, or about 1 lbₘ/bbl to about 6 lbₘ/bbl of fluid-loss control additive, or about 1.5 lbₘ/bbl to about 8 lbₘ/bbl of fluid-loss control additive, or about 1.5 lbₘ/bl to about 2.5 lbₘ/bbl of fluid-loss control additive. Commercially available example fluid-loss control additives include VERSACOAT™ VERSATROL™, VERSALIG™, ECOTROL™ RD, ONETROL™ HT, EMI 789, and NOVATECH™ F, all from MI SWACO, and DURATONE® HT which is from Halliburton Energy Services, Inc. In one or more embodiments, the fluid-loss control additive may be a methylstyrene/acrylate copolymer filter control agent such as ADAPTA® which is commercially available from Halliburton Energy Services, Inc.

In one or more embodiments, additives in the drilling fluid may include one or more alkaline compounds for pH adjustment, which may include lime (calcium hydroxide or calcium oxide), soda ash (sodium carbonate), sodium hydroxide, potassium hydroxide, other strong bases, or any combination thereof. It is noted that conjugate bases to acids with a pKₐ of more than about 13 are considered strong bases. The pH may be maintained within a range in order to minimize corrosion caused by the drilling fluid on steel tubulars, tanks, pumps, and other equipment contacting the drilling fluid. Additionally, the alkaline compounds may react with gases, such as carbon dioxide or hydrogen sulfide for example, encountered by the drilling fluid during drilling operations to prevent the gases from hydrolyzing one or more components of the drilling fluid. Some example drilling fluids may include about 0.1 lbₘ/bbl to about 10 lbₘ/bbl of alkaline compound, or about 0.5 lbₘ/bbl to about 5 lbₘ/bbl or alkaline compound, or about 1 lbₘ/bbl to about 2 lbₘ/bbl of alkaline compound.

One skilled in the art can appreciate that the drilling fluid may include one or more additional modifiers to alter a characteristic of the drilling fluid. Examples of additional modifiers may include, but are not limited to, pH adjusters, electrolytes, glycols, glycerols, dispersion aids, corrosion inhibitors, defoamers, the like, and any combination thereof.

During circulation of the drilling fluid through the wellbore, the drilling fluid may accumulate cuttings and other solids. Additionally, the drilling fluid itself may have solids dispersed throughout, such as weighting material. During circulation of the drilling fluid, the solids are continuously mixed and suspended within the drilling fluid. However, when circulation of the drilling fluid is interrupted or terminated, the solids may settle or separate from the bulk of the drilling fluid based on the rheology of the drilling fluid. Settling of the cuttings and other solids is undesirable because they would accumulate at the bottom of the wellbore and potentially prevent the drill from rotating or completely block the flow path of the drilling fluid upon resumption of drilling activities.

The rheology of the drilling fluid may be evaluated from the plastic viscosity (PV) and yield point (YP), which are parameters from the Bingham plastic rheology model. The PV is related to the resistance of the drilling fluid to flow due to mechanical interaction between the solids of the drilling fluid and represents the viscosity of the drilling fluid extrapolated to infinite shear rate. The PV reflects the type and concentration of the solids in the drilling fluid, and a lesser PV is preferred. The PV of the drilling fluid may be estimated by measuring the shear rate of the drilling fluid using a viscometer at spindle speeds of 300 rpm and 600 rpm and subtracting the 300 rpm measurement from the 600 rpm measurement according to Equation 1. The PV is provided in this disclosure in units of centipoise (cp).

$$P V = ( 600 r p m reading ) - ( 300 r p m reading ) \qquad Equation 1$$

The drilling fluid may, for example, have a PV of about 10 cp to about 25 cp, or about 10 cp to about 20 cp, or about 10 cp to about 15 cp, or about 15 cp to about 25 cp, or about 15 cp to about 20 cp, or about 20 cp to about 25 cp.

The YP represents the shear stress below which the drilling fluid behaves as a rigid body and above which the drilling fluid flows as a viscous fluid. Specifically, the YP represents the amount of stress required to move the drilling fluid from a static condition. The YP is expressed as a force per area, such as pounds of force per one hundred square feet (lb_{f}/100 ft²). The YP provides an indication of the carrying capacity of the drilling fluid for rock cuttings through the annulus, which provides an indication of the hole-cleaning ability of the drilling fluid. Additionally, frictional pressure loss is directly related to the YP. For higher YPs, there will be higher pressure loss while the drilling fluid is being circulated.

The YP is determined by extrapolating the Bingham plastic rheology model to a shear rate of zero. The YP may be estimated by subtracting the PV obtained from Equation 1 from the shear rate of the drilling fluid measured at 300 rpm according to Equation 2.

$$Y P = ( 300 r p m reading ) - P V \qquad Equation 2$$

The drilling fluid may, for example, have a YP of about 1 lb_{f}/100 ft² to about 15 lb_{f}/100 ft², or about 1 lb_{f}/100 ft² to about 10 lb_{f}/100 ft², or about 1 lb_{f}/100 ft² to about 5 lb_{f}/100 ft², or about 5 lb_{f}/100 ft² to about 15 lb_{f}/100 ft², or about 5 lb_{f}/100 ft² to about 10 lb_{f}/100 ft², or about 10 lb_{f}/100 ft² to about 15 lb_{f}/100 ft².

The spurt loss is the instantaneous volume (spurt) of drilling fluid that passes through a filter medium prior to the deposition of a competent and controlling filter cake. For example, the drilling fluid may have a spurt loss of about 1 mL to about 10 mL, or about 1 mL to about 5 mL, or about 5 mL to about 10 mL.

### Embodiments Disclosed Herein Include:

A. A drilling fluid including: a base fluid, wherein the base fluid is an emulsion comprising an oil and an aqueous fluid; wherein the aqueous fluid comprises a concentrated brine obtained from desalinating a produced water; and one or more additives.

B. A method for using a drilling fluid including: performing desalination on a produced water to obtain a concentrated brine; and operating drill in a wellbore in the presence of a drilling fluid comprising a base fluid, wherein the base fluid is an emulsion comprising an oil and an aqueous fluid; wherein the aqueous fluid comprises the concentrated brine; and one or more additives.

C. A drilling fluid including: a base fluid, wherein the base fluid is an emulsion comprising an oil and an aqueous fluid; wherein the oil comprises diesel, Safra oil, or a combination thereof; wherein the aqueous fluid comprises about 25 vol % to about 75 vol % of a concentrated brine obtained from desalinating a produced water; a viscosifier; an emulsifier; a weighting material; a fluid-loss additive; and an alkaline compound.

Each of embodiments A, B, and C may have one or more of the following additional elements in any combination:

Element 1: wherein the aqueous fluid has a concentration of the concentrated brine of about 25 vol % to about 75 vol %.

Element 2: wherein the concentrated brine comprises ions of sulfate, chloride, bicarbonate, sodium, potassium, calcium, magnesium, or any combination thereof.

Element 3: wherein the oil comprises diesel, Safra oil, kerosene, fuel oil, crude oil, mineral oil, or any combination thereof.

Element 4: wherein the one or more additives comprise a viscosifier, an emulsifier, a weighting material, a fluid-loss additive, an alkaline compound, or any combination thereof.

Element 5: wherein a plastic viscosity (PV) of the drilling fluid is about 10 cp to about 25 cp.

Element 6: wherein a yield point (YP) of the drilling fluid is about 1 lb_{f}/100 ft² to about 15 lb_{f}/100 ft².

Element 7: wherein a spurt loss of the drilling fluid is about 1 mL to about 10 mL.

By way of non-limiting example, exemplary element combinations applicable to A, B and C include: 1 with 2; 1 with 3; 1 with 4; 1 with 5; 1 with 6; 1 with 7; 2 with 3; 2 with 4; 2 with 5; 2 with 6; 2 with 7; 3 with 4; 3 with 5; 3 with 6; 3 with 7; 4 with 5; 4 with 6; 4 with 7; 5 with 6; 5 with 7; 6 with 7; 1 with 2 and 3; 2 with 3 and 4; 3 with 4 and 5; 4 with 5 and 6; 5 with 6 and 7; and 1 with 2-4.

The present disclosure is further directed to the following non-limiting clauses: Clause 1. A drilling fluid comprising:
a base fluid, wherein the base fluid is an emulsion comprising an oil and an aqueous fluid;
   wherein the aqueous fluid comprises a concentrated brine obtained from desalinating a produced water; and one or more additives.

Clause 2. The drilling fluid of clause 1, wherein the aqueous fluid has a concentration of the concentrated brine of about 25 vol % to about 75 vol %.

Clause 3. The drilling fluid of clause 1 or clause 2, wherein the concentrated brine comprises ions of sulfate, chloride, bicarbonate, sodium, potassium, calcium, magnesium, or any combination thereof.

Clause 4. The drilling fluid of any one of clauses 1-3, wherein the oil comprises diesel, Safra oil, kerosene, fuel oil, crude oil, mineral oil, or any combination thereof.

Clause 5. The drilling fluid of any one of clauses 1-4, wherein the one or more additives comprise a viscosifier, an emulsifier, a weighting material, a fluid-loss additive, an alkaline compound, or any combination thereof.

Clause 6. The drilling fluid of any one of clauses 1-5, wherein a plastic viscosity (PV) of the drilling fluid is about 10 cp to about 25 cp.

Clause 7. The drilling fluid of any one of clauses 1-6, wherein a yield point (YP) of the drilling fluid is about 1 lb_{f}/100 ft² to about 15 lb_{f}/100 ft².

Clause 8. The drilling fluid of any one of clauses 1-7, wherein a spurt loss of the drilling fluid is about 1 mL to about 10 mL.

Clause 9. A method comprising:
performing desalination on a produced water to obtain a concentrated brine; and
operating a drill in a wellbore in the presence of a drilling fluid comprising:
   a base fluid, wherein the base fluid is an emulsion comprising an oil and an aqueous fluid;
      wherein the aqueous fluid comprises the concentrated brine; and one or more additives.

Clause 10. The method of clause 9, wherein the aqueous fluid has a concentration of the concentrated brine of about 25 vol % to about 75 vol %.

Clause 11. The method of clause 9 or clause 10, wherein the concentrated brine comprises ions of sulfate, chloride, bicarbonate, sodium, potassium, calcium, magnesium, or any combination thereof.

Clause 12. The method of any one of clauses 9-11, wherein the oil comprises diesel, Safra oil, kerosene, fuel oil, crude oil, mineral oil, or any combination thereof.

Clause 13. The method of any one of clauses 9-12, wherein the one or more additives comprise a viscosifier, an emulsifier, a weighting material, a fluid-loss additive, an alkaline compound, or any combination thereof.

Clause 14. The method of any one of clauses 9-13, wherein a plastic viscosity (PV) of the drilling fluid is about 10 cp to about 25 cp.

Clause 15. The method of any one of clauses 9-14, wherein a yield point (YP) of the drilling fluid is about 1 lb/100 ft² to about 15 lb/100 ft².

Clause 16. The method of any one of clauses 9-15, wherein a spurt loss of the drilling fluid is about 1 mL to about 10 mL.

Clause 17. A drilling fluid comprising:
a base fluid, wherein the base fluid is an emulsion comprising an oil and an aqueous fluid;
   wherein the oil comprises diesel, Safra oil, or a combination thereof;
   wherein the aqueous fluid comprises about 25 vol % to about 75 vol % of a concentrated brine obtained from desalinating a produced water;
a viscosifier;
an emulsifier;
a weighting material;
a fluid-loss additive; and
an alkaline compound.

### EXAMPLES

Comparative and experimental drilling fluids were prepared according to the compositions of the present disclosure. The comparative drilling fluids comprised an aqueous fluid consisting only of water, while the experimental drilling fluids comprised an aqueous fluid consisting of 50 vol % calcium chloride brine and 50 vol % water. Table 1 shows the compositions of the comparative and experimental drilling fluids.

TABLE 1

| Component | Amount | |
|---|---|---|
| Oil (diesel or Safra oil) | 218 | mL |
| Emulsifier | 12 | mL |
| Lime | 6 | g |
| Viscosifier | 4 | g |
| Fluid-loss additive | 6 | g |
| Aqueous fluid | 85 | mL |
| Barite | 161 | g |

Each drilling fluid was hot rolled for 16 hours to simulate downhole conditions of 300° F. and 500 psi. The rheological properties of the drilling fluids following hot rolling are shown in Table 2.

TABLE 2

| | Diesel-Based | | Safra Oil-Based | |
|---|---|---|---|---|
| | Comparative | Experimental | Comparative | Experimental |
| Property | Drilling Fluid 1 | Drilling Fluid 1 | Drilling Fluid 2 | Drilling Fluid 2 |
| PV (cp) | 15 | 12 | 13 | 23 |
| YP (lb_{f}/100 ft²) | 3 | 4 | 13 | 13 |
| Spurt loss (mL) | 2 | 4 | 6 | 2 |
| Total loss (mL) | 14 | 6 | 10 | 6 |
| Mud cake (mm) | 3.175 | 4.175 | 4.175 | 3.175 |

As shown in Table 2, the comparative and experimental drilling fluids exhibited similar rheological properties for both the diesel- and Safra oil-based drilling fluids. This indicates that a concentrated brine may be used as a component of the aqueous fluid in an oil-based drilling fluid without compromising fluid rheology.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized that these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and are not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

The invention claimed is:

1. A drilling fluid comprising:
a base fluid, wherein the base fluid is an emulsion comprising an oil and an aqueous fluid;
wherein the aqueous fluid comprises a concentrated brine obtained from desalinating a produced water; and
one or more additives.

2. The drilling fluid of claim 1, wherein the aqueous fluid has a concentration of the concentrated brine of about 25 vol % to about 75 vol %.

3. The drilling fluid of claim 1, wherein the concentrated brine comprises ions of sulfate, chloride, bicarbonate, sodium, potassium, calcium, magnesium, or any combination thereof.

4. The drilling fluid of claim 1, wherein the oil comprises diesel, Safra oil, kerosene, fuel oil, crude oil, mineral oil, or any combination thereof.

5. The drilling fluid of claim 1, wherein the one or more additives comprise a viscosifier, an emulsifier, a weighting material, a fluid-loss additive, an alkaline compound, or any combination thereof.

6. The drilling fluid of claim 1, wherein a plastic viscosity (PV) of the drilling fluid is about 10 cp to about 25 cp.

7. The drilling fluid of claim 1, wherein a yield point (YP) of the drilling fluid is about 1 lb_{f}/100 ft² to about 15 lb_{f}/100 ft².

8. The drilling fluid of claim 1, wherein a spurt loss of the drilling fluid is about 1 mL to about 10 mL.

9. A method comprising:
performing desalination on a produced water to obtain a concentrated brine; and
operating a drill in a wellbore in the presence of a drilling fluid comprising:
a base fluid, wherein the base fluid is an emulsion comprising an oil and an aqueous fluid;
wherein the aqueous fluid comprises the concentrated brine; and
one or more additives.

10. The method of claim 9, wherein the aqueous fluid has a concentration of the concentrated brine of about 25 vol % to about 75 vol %.

11. The method of claim 9, wherein the concentrated brine comprises ions of sulfate, chloride, bicarbonate, sodium, potassium, calcium, magnesium, or any combination thereof.

12. The method of claim 9, wherein the oil comprises diesel, Safra oil, kerosene, fuel oil, crude oil, mineral oil, or any combination thereof.

13. The method of claim 9, wherein the one or more additives comprise a viscosifier, an emulsifier, a weighting material, a fluid-loss additive, an alkaline compound, or any combination thereof.

14. The method of claim 8, wherein a plastic viscosity (PV) of the drilling fluid is about 10 cp to about 25 cp.

15. The method of claim 9, wherein a yield point (YP) of the drilling fluid is about 1 lb_{f}/100 ft² to about 15 lb_{f}/100 ft².

16. The method of claim 9, wherein a spurt loss of the drilling fluid is about 1 mL to about 10 mL.

17. A drilling fluid comprising:
a base fluid, wherein the base fluid is an emulsion comprising an oil and an aqueous fluid;
wherein the oil comprises diesel, Safra oil, or a combination thereof;
wherein the aqueous fluid comprises about 25 vol % to about 75 vol % of a concentrated brine obtained from desalinating a produced water;
a viscosifier;
an emulsifier;
a weighting material;
a fluid-loss additive; and
an alkaline compound.
